(19) United States
(12) Patent Application Publication
(10) Pub. No.: US 2022/0134369 A1
(43) Pub. Date: May 5, 2022

(54) WIRELESS VARIABLE PRESSURE SPRAYER AND METHOD

(71) Applicant: Wessol, LLC, Charlotte, NC (US)

(72) Inventors: Joseph J. Gustafson, Charlotte, NC (US); Steven Norris, Maineville, OH (US)

(21) Appl. No.: 17/245,571

(22) Filed: Apr. 30, 2021

Related U.S. Application Data
(60) Provisional application No. 63/109,608, filed on Nov. 4, 2020.

(51) Int. Cl. B05B 12/08; B05B 9/01; B05B 9/08

(52) U.S. Cl. CPC B05B 12/085; B05B 9/0861; B05B 9/01

(57) ABSTRACT

A wireless variable pressure sprayer that includes a housing in which is mounted a battery, a battery-operated motor, and a motor-operated liquid pump. A tank communicates with the pump for holding a supply of liquid and a user operable spray gun is connected for liquid flow communication from the tank. A wireless transmitter is positioned in the spray gun and is adapted to transmit a wireless signal to a receiver/controller for supplying current from the battery to the motor sufficient to cause the motor operated pump to deliver liquid through the gun and into an applicator wand.

### PRIORITY CLAIM

This application claims priority from Provisional Patent Application Ser. No. 63/019,608, filed May 4, 2020, the contents of which are incorporated by reference into this utility application.

### TECHNICAL FIELD AND BACKGROUND OF INVENTION

This invention relates to a variable pressure sprayer that uses a wireless signal from the spray gun to vary the pressure and/or flow rate with which a liquid is dispensed from the sprayer.

Prior art sprayers work on the principle that when the user opens the sprayer nozzle through the trigger mechanism, the pressure in the system drops and a pressure switch built into the pump senses the pressure drop and closes a switch turning the pump motor on and thus the sprayer to start spraying. When the user closes the spray nozzle by releasing the trigger mechanism the pressure switch senses the pressure increase and opens a set of contacts causing the pump motor to turn off.

Conventional electric sprayers use a pressure switch to turn on and off the electric pump. When the user of the sprayer opens the valve on the spray gun the pressure in the system drops causing the pressure switch to turn on the pump and supply liquid. When the user closes the valve on the gun, the pressure increases causing the pressure switch to turn off the pump. A problem arises when a user utilizes a nozzle that does not allow enough flow and causes the pressure to increase enough in the system so that the pressure switch turns off the pump even though the user has the valve open on the gun. Since the valve is open, the pressure immediately drops below the pressure switch threshold causing the pump to restart. As soon as the pump turns back on, the pressure rises past the threshold and the pump turns off again. This on/off cycle occurs rapidly and causes excessive wear on the pressure switch and the pump, reducing the life of the system or even causing complete failure.

As a separate matter, an electrical switch mounted in the spray gun may be used to control the operation of the motor operated liquid pump. Wires are then necessary to control the operation of the sprayer and may be damaged during normal use, rendering the sprayer inoperable. One such example is U.S. Patent Publication No. 2019/0263363. When the user opens the gun valve the switch also actuates a microswitch turning on the pump. The pump runs continuously until the user closes the valve, causing the microswitch to open and shut off the pump. This design requires control wires to be run from the sprayer unit to the gun via the system's hose. The control wires then must be protected from the environment by re-wrapping the hose with a protective coating. The control wires are still susceptible to damage from field conditions that can nick or cut the wires.

Therefore, in accordance with the invention of this application, the pump in the sprayer is controlled wirelessly by putting a module in the spray gun that sends a wireless signal to a receiver in the spray gun directing the pump to start. This eliminates the need for a pressure switch on the pump, a microswitch in the spray gun, and control wires wrapped on the hose. This wireless signal can then be used not only to turn the unit on and off, but also to let the user control the speed of the pump, thus controlling the output pressure and/or flow rate. The signal can also be used for feedback such that the user can “set” the desired pressure and/or flow rate and let the pump speed change according to flow such that the desired pressure and/or flow rate is constant.

### SUMMARY OF THE INVENTION

According to one aspect of the invention a wireless power sprayer is provided that is capable of dispensing a liquid from the supply tank at varying pressures and/or flow rates.

According to one aspect of the invention a wireless power sprayer is provided that is controlled wirelessly by providing a transmitter in a spray gun that sends a wireless signal to a receiver activating a pump that delivers liquid from a storage tank to the spray gun.

According to another aspect of the invention a wireless power sprayer is provided that uses a speed control to vary the pressure and/or flow with which a liquid is dispensed from the pump.

According to another aspect of the invention a wireless power sprayer is provided with a trigger on the spray gun of the applicator wand that is actuated with an electrical switch, or other electrical circuit capable of sensing trigger actuation and a module that sends the wireless signal to the receiver for activating the pump.

According to another aspect of the invention a method of operating a wireless variable pressure sprayer is provided that uses a speed controller to vary the pressure and/or flow rate with which a liquid is dispensed from the sprayer.

These and other aspects of the invention are accomplished by providing a wireless variable pressure sprayer that includes a housing in which is mounted a battery, a battery-operated motor, a motor-operated liquid pump, and a speed controller module capable of receiving a wireless signal. A tank is provided and communicates with the pump for holding a supply of liquid. A user operable spray gun is connected for liquid flow communication from the tank. A wireless transmitter is positioned in the spray gun and adapted to transmit a wireless signal to a receiver/controller positioned proximate to the battery and motor-operated liquid pump, adapted for supplying current from the battery to the motor sufficient to cause the motor operated liquid pump to deliver liquid through the spray gun and into an applicator wand.

According to another embodiment of the invention, a liquid outlet from the pump includes a connector adapted to receive a hose.

According to another embodiment of the invention, an applicator wand is provided and is adapted for connection to the spray gun and hose for directing fluid under pressure to a desired target.

According to another embodiment of the invention, the spray gun, including a trigger, is positioned on the applicator wand and adapted to wirelessly transmit a signal indicating the pressure and/or flow rate of the liquid to be delivered from the pump to the spray gun.

According to another embodiment of the invention, a variable pressure and/or flow rate controller is positioned on the housing and connected to the motor for varying an output pressure and/or flow percentage of the pump.

According to another embodiment of the invention, the battery supplies a suitable voltage, for example, 18 V direct current, to the motor that powers the pump, the pump is adapted to draw liquid from the tank through a pump input conduit, the pump pressurizes the liquid, and discharges the liquid into an output conduit that is connected through a sidewall of the housing to the hose.

According to another embodiment of the invention, the wireless variable pressure sprayer is adapted to supply liquid at a manually selectable high or low pressure.

According to another embodiment of the invention, the wireless variable pressure sprayer is adapted to supply liquid at a manually selectable high or low flow rate.

According to another embodiment of the invention, the pump is controlled wirelessly via a signal transmitted from the spray gun to a signal receiver operatively associated with the motor indicative of an instruction to the pump to turn on.

According to another embodiment of the invention, the spray gun is adapted for manual operation by a user wirelessly controlling the output pressure and/or flow rate of the liquid by operation of the spray gun.

According to another embodiment of the invention, a pressure transducer or flow meter is placed at the output of the motor operated liquid pump, the signal is adapted for being fed back to the electronic control module whereby the user can manually set a desired pressure and/or flow rate and the pump speed changes according to pressure and/or flow rate as determined by the pressure transducer or flow meter such that the desired pressure and/or flow rate is constant.

According to another embodiment of the invention, the trigger is provided with two positions correlated to the desired pressure, and a demand for high or low pressure causes a wireless signal to be transmitted from the electronic control module to a receiver/controller on the motor to transmit current from the battery to the motor sufficient to cause the pump to deliver the desired pressure and/or flow of liquid through the hose, the spray gun and into the applicator wand.

According to another embodiment of the invention, the trigger includes a switch that when switched on, causes the transmitter in the spray gun to transmit a signal correlated to a specific desired pressure within a predetermined range of pressures and/or flow rate.

According to another embodiment of the invention, a method of providing a liquid at a variable pressure to an applicator wand includes the steps of providing a housing on which is mounted a battery, a battery-operated motor, and a motor-operated liquid pump, a tank communicating with the pump for holding a supply of liquid and a spray gun connected for liquid flow communication from the tank. A wireless transmitter is positioned in the spray gun and adapted to transmit a wireless signal to a receiver/controller, signaling the battery to transmit current from the battery to the motor operated pump sufficient to cause the pump to deliver liquid through the spray gun and into the applicator wand to wirelessly control the output pressure of the liquid by operation of the spray gun.

According to another embodiment of the invention, the method includes the step of supplying liquid at a manually selectable high or low pressure.

According to another embodiment of the invention, the method includes the step of supplying liquid at a manually selectable high or low flow rate.

According to another embodiment of the invention, the method includes the step of feeding back a pressure and/or flow rate signal to the electronic control module whereby the user can manually set a desired pressure and/or flow rate and the pump speed changes such that the desired pressure and/or flow rate is constant.

According to another embodiment of the invention, the method includes the step of transmitting a wireless signal correlated to a specific desired pressure and/or flow within a predetermined range of pressures and/or flows to the pump, determined by a position of the trigger that is correlated to predetermined range of pressures.

According to another embodiment of the invention, a method of providing a liquid at a variable pressure to an applicator wand includes the steps of providing a housing on which is mounted a battery, a battery-operated motor, and a motor-operated liquid pump. A tank communicates with the pump for holding a supply of liquid and a spray gun is connected for liquid flow communication with the tank. A wireless transmitter is positioned in the spray gun and adapted to transmit a wireless signal to a receiver/controller, signaling the battery to transmit current from the battery to the motor sufficient to operate the motor operated pump to cause the pump to deliver liquid through the spray gun and into a manually-directed applicator wand at a manually selectable high or low pressure. The spray gun is manually operated to wirelessly control the output of the liquid by operation of the spray gun. The wireless signal is fed back to an electronic control module whereby the user can manually set a desired pressure that changes according to flow such that the desired pressure is constant. The wireless signal is correlated to a specific desired pressure and/or flow rate within a predetermined range of pressures and/or flow rates to the pump.

### BRIEF DESCRIPTION OF THE FIGURES

The present invention is best understood when the following detailed description of the invention is read with reference to the accompanying drawings, in which:

FIG. 1 is a top view of the wireless sprayer, including hose and applicator wand;

FIG. 2 is a front elevation of the wireless sprayer housing, with cover removed, including hose and applicator wand;

FIG. 3 is a schematic flow chart of a two-speed wireless sprayer;

FIG. 4 is a schematic flow chart of a variable speed wireless sprayer;

FIG. 5 is a circuit diagram of a spray gun of a wireless sprayer according to one embodiment of the invention with two speed control;

FIG. 6 is a circuit diagram of a tank unit of a wireless sprayer according to an embodiment of the invention with two speed control;

FIG. 7 is a circuit diagram of a spray gun of a wireless sprayer according to another embodiment of the invention with variable speed control; and

FIG. 8 is a circuit diagram of a tank unit of a wireless sprayer according to an embodiment of the invention with variable speed control.

### DETAILED DESCRIPTION OF THE PREFERRED EMBODIMENT AND BEST MODE

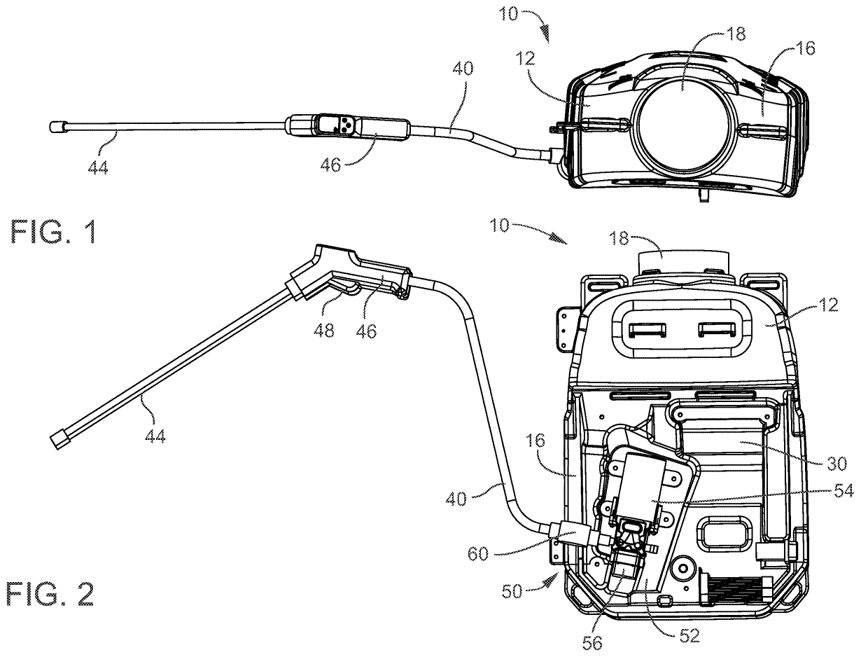

Referring now to FIGS. 1 and 2, wireless variable pressure sprayer 10 includes a housing 12 that encloses the operating elements of the sprayer 10. The sprayer 10 may be carried on the back of the user by a shoulder strap assembly, not shown, that is mounted to the back of the housing 12. The sprayer 10 may also be mounted on wheels so that it can be rolled instead of carried. The housing 12 encloses a tank 16 which will typically hold approximately 15 liters of liquid. The tank 16 is accessed through a threaded cap 18.

A battery 30, such as a lithium ion battery, is mounted on the housing 12. Liquid under pressure is dispensed from the sprayer 10 through a hose 40 that connects to an applicator wand 44. The applicator wand 44 includes a spray gun 46 with a trigger 48 that is manually grasped by the user, and which operates a valve, not shown, in the spray gun 46 that permits the pressure of the liquid to be controlled.

A variable pressure controller 50 is mounted externally to the side of the housing 12 and communicates with a controller housing 52 in the lower part of the housing 12. The battery 30 supplies nominal 18 V current to a motor 54 that drives a pump 56. The pump 56 draws liquid from the tank 16 through a pump input conduit that pressurizes the liquid and discharges it into an output conduit 60 that is connected through the sidewall of the housing 12 to the discharge hose 40.

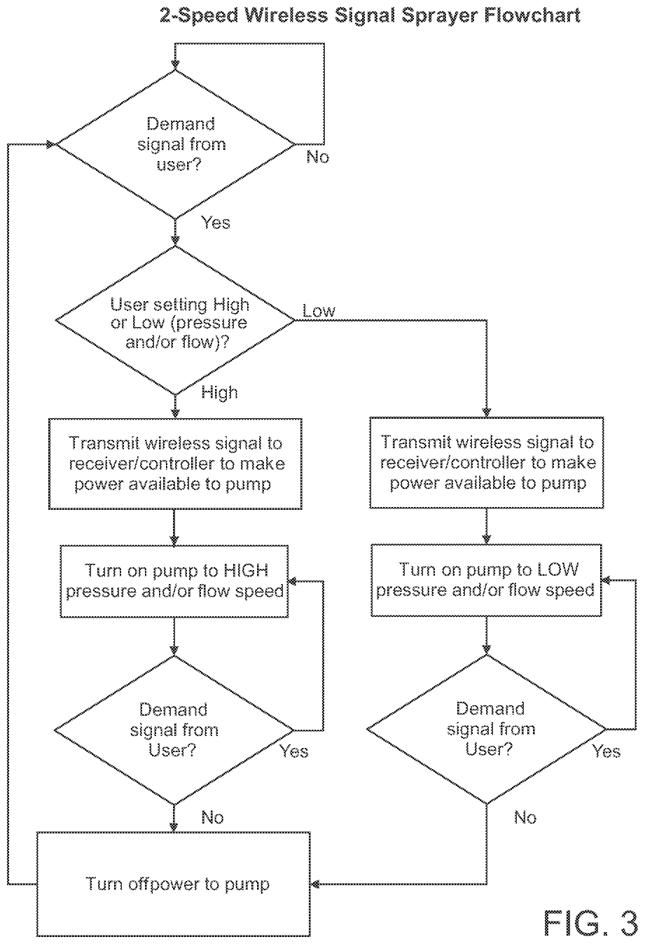

Referring now to FIG. 3, a two-speed version of the sprayer 10 is explained. The sprayer is manually set to ether a high or low pressure and/or flow rate. The pump 56 in the sprayer 10 is controlled wirelessly by a module in the spray gun 46 that sends a wireless signal to a receiver in the spray gun 46 signaling it to turn on. This eliminates the need for a pressure switch on the pump 56, and control wires wrapped on the hose 40. This wireless signal can then be used not only to turn the unit on and off, but also to let the user control the speed of the pump, thus controlling the output pressure and/or flow rate.

Referred to broadly as “Demand Signal”, this may be depressing the trigger 48. As shown, a demand for high pressure or flow rate causes a wireless signal to be transmitted from a transmitter to a receiver/controller, signaling the motor 54 to operate at a set high speed determined by the current and voltage supplied by the controller. The high motor speed causes the pump 56 to deliver liquid at a high pressure and/or flow rate of liquid through the hose 40, through the spray gun 46 and into the wand 44.

Conversely, as shown, a demand for low pressure or flow rate causes a wireless signal to be transmitted from a transmitter to a receiver/controller, signaling the motor 54 to operate at a set low speed determined by the current and voltage supplied by the controller. The low motor speed causes the pump 56 to deliver liquid at a low pressure and/or flow rate through the hose 40, through the spray gun 46 and into the wand 44.

A further demand signal from the transmitter either signals the receiver/controller to continue pumping at either high or low pressure or flow rate, or to turn off power to the pump 56.

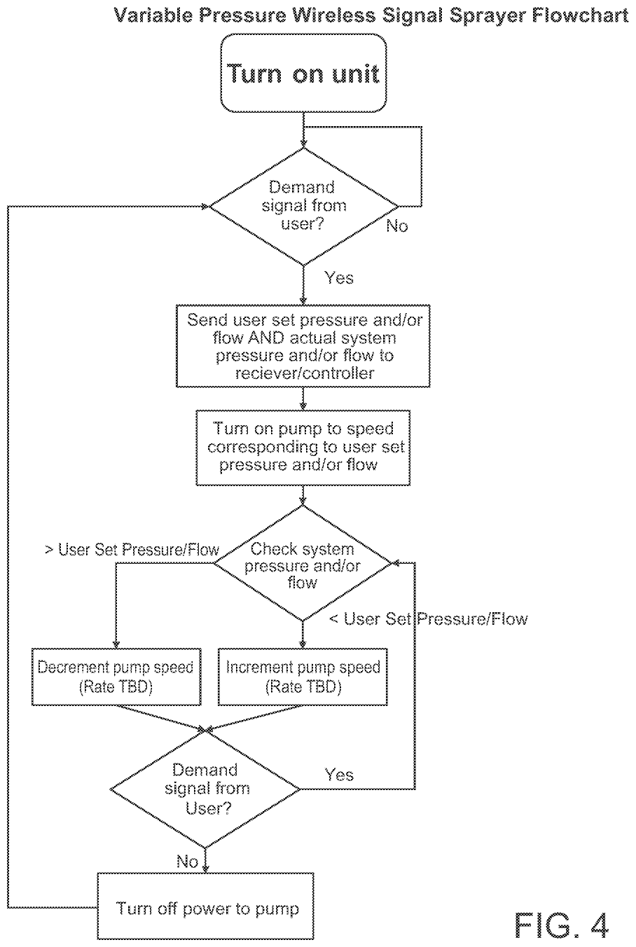

Referring now to FIG. 4, a system is illustrated schematically that permits variable pressure and/or flow rate between a high and low range to be delivered. Preferably, the sprayer 10 has a master ON/OFF switch. When switched on, the trigger 48 of the spray gun 46, when depressed, causes the transmitter in spray gun 46 to transmit a signal correlated to a specific pressure and/or flow rate within the permitted range of pressures. Upon receipt of a demand signal from the user depressing the trigger 48 a wireless signal is to be transmitted from the transmitter to a receiver/controller, signaling the motor 54 to operate the pump 56 sufficient to cause the pump 56 to deliver liquid at the specified pressure and/or flow rate liquid through the hose 40, through the spray gun 46 and into the wand 44.

Alternatively, a variable speed controller, such as a rotatable dial or user operable display, may be positioned on the spray gun 46 to allow the user to change the signal the transmitter emits and thus changing the pressure and/or flow rate of the liquid to be delivered to the wand 44.

As also shown in FIG. 4, the user may increment or decrement the pump speed. With a demand signal from the user a signal is sent to check system pressure and/or flow. With no demand signal from the user, the power to the pump 56 is turned off.

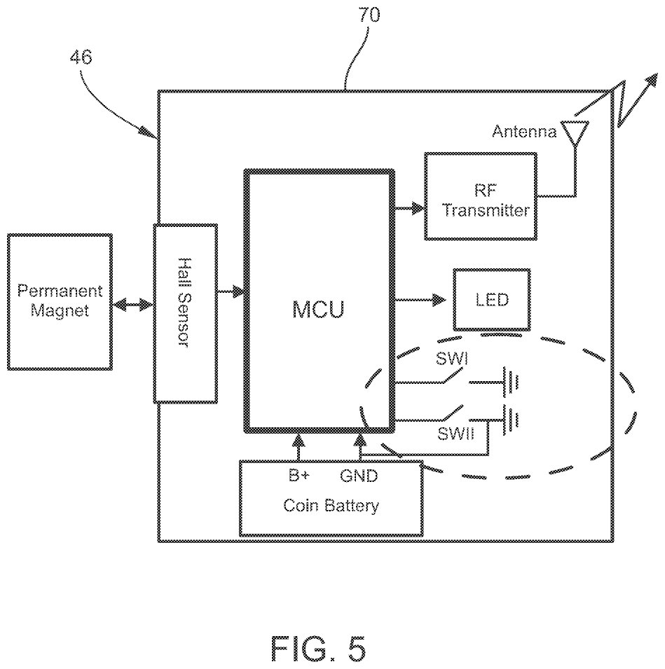

Referring to FIGS. 5-8, circuit diagrams are provided for two iterations of a wireless sprayer, one having two-speed operation and one with variable speed operation.

As shown in FIG. 5, the spray gun 46 includes a circuit 70 with a two-speed on/off function. The circuit 70 operates in a standby mode until a permanent magnet operated by the trigger 48 is moved by the trigger 48 into proximity of a Hall effect sensor. A microcontroller unit (“MCU”) detects the Hall effect sensor signal and transmits via an antenna a wireless signal to command the motor 54 to operate the pump 56 to deliver liquid from the tank 16. The liquid pressure and/or flow rate is user selectable with pump speed switches SW1 and SWII. The circuit 70 is powered by a coin battery, for example, a CR2032 battery. If the battery power falls below a threshold value the MCU triggers the LED flash display to indicate that the battery requires replacement.

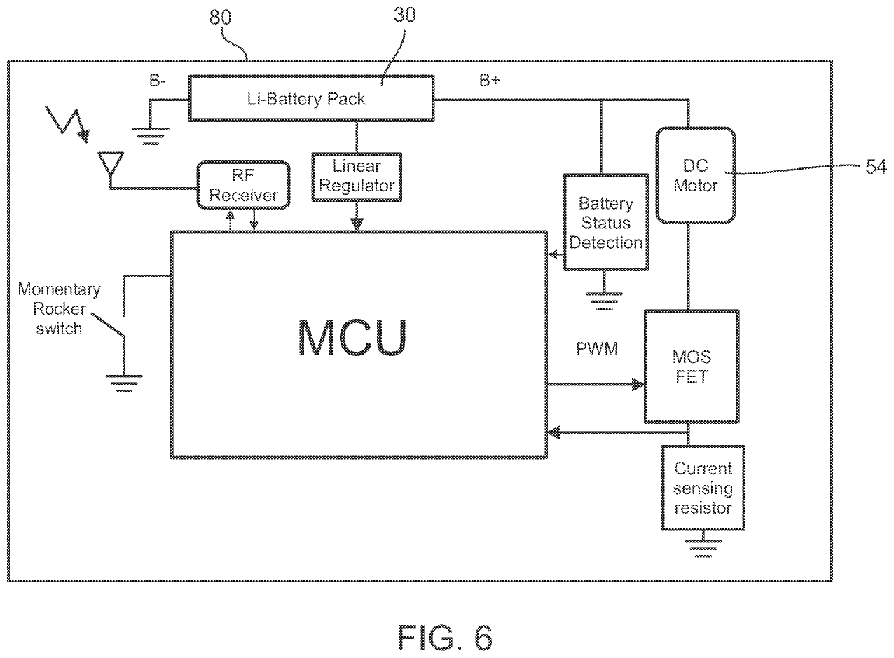

Tank operation is shown in FIG. 6. Delivery of liquid from the tank 16 is initiated by a wireless signal from the spray gun 46 containing trigger state and selected pressure and/or flow rate. A wireless receiver decodes the signal and sends a data protocol to the MCU to initiate operation of the tank 16. The lithium battery 30 delivers direct current to the DC motor 54 and provides MCU stable power via a linear regulator. The MCU delivers a pulse wave modulated (“PWM”) signal to drive a MOSFET according to the selected pressure and/or flow rate determined by the wireless command signal. The current sensing resistor monitors the status of the motor 54 to protect against an unwanted stall event. The MCU continually detects the voltage of the battery 30 and automatically shuts down the machine when the voltage drops below a threshold value.

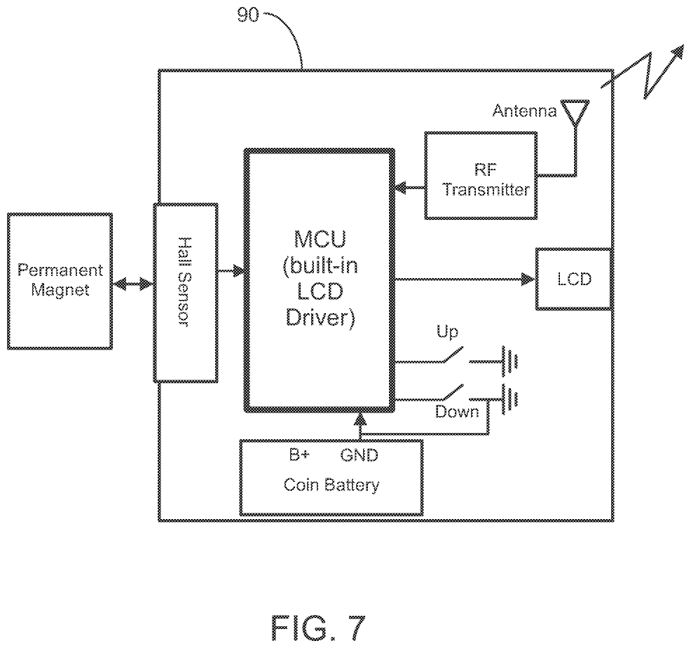

Referring to FIG. 7, a circuit 90 with an ON/OFF function with variable speed control is shown and explained. The circuit operates in a standby mode until a permanent magnet operated by the trigger 48 is moved by the trigger 48 into proximity of a Hall effect sensor. The MCU in the spray gun detects the Hall effect sensor signal and sends a wireless signal via the antenna. The signal contains trigger state and desired pressure and/or flow rate. The signal is received by another MCU located on the housing that produces a signal to command the motor 54 to operate the pump 56 to deliver liquid from the tank 16. The user controls the spray gun 46 by operation of an UP/DOWN switch that changes the wireless command signal-to increase or decrease power delivered to the motor 54 as needed to control output of the pump 56 as desired.

The circuit 90 is powered by a coin battery, for example, a CR2032 battery. If the battery power falls below a threshold value the MCU, which includes a built-in LCD driver, triggers the LCD display to indicate that the battery requires replacement.

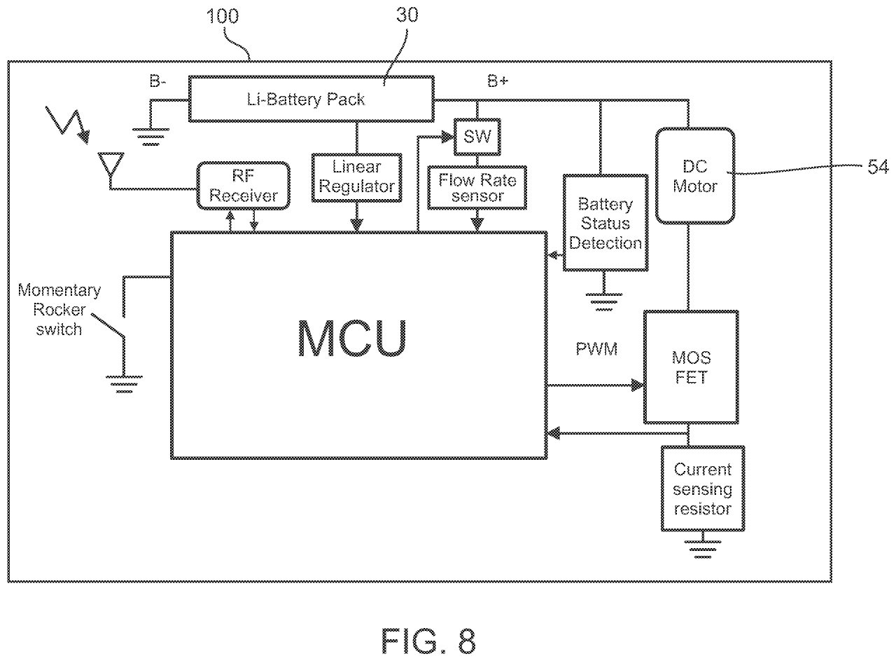

Referring now to FIG. 8, a circuit 100 operates the delivery of the liquid from the tank 16. Delivery of liquid from the tank 16 is initiated by a wireless signal from the spray gun 46 which activates operation of the motor 54. A wireless receiver decodes the wireless signal and sends a data protocol to the MCU to execute operation of the pump. The lithium battery 30 delivers direct current to the motor 54 and provides MCU stable power via a linear regulator.

The MCU delivers a PWM signal to drive a MOSFET according to the wireless command signal. A pressure and/or flow rate sensor is connected to the pump output and there is a feedback loop within the MCU that automatically adjusts the PWM duty cycle in the motor circuit to achieve the selected pressure and/or flow rate communicated through the wireless command signal from the spray gun. The current sensing resistor monitors the status of the motor 54 to protect against an unwanted stall event. The MCU continually detects the voltage of the battery 30 and automatically shuts down the machine when the voltage drops below a threshold value. In order to save battery power, the pressure sensor and/or flow rate sensor turns on via an MCU command only if the motor 54 is running.

A wireless variable pressure sprayer according to the invention has been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

We claim:

1. A wireless variable pressure sprayer, comprising:
(a) a housing in which is mounted a battery, a battery-operated motor, and a motor-operated liquid pump;
(b) a tank communicating with the pump for holding a supply of liquid;
(c) a user operable spray gun connected for liquid flow communication from the tank; and
(d) a wireless transmitter positioned in the spray gun and adapted to transmit a wireless signal to a receiver/controller adapted for supplying current from the battery to the motor sufficient to cause the motor operated pump to deliver liquid through the spray gun and into an applicator wand.

2. A wireless variable pressure sprayer according to claim 1, and including a liquid outlet from the pump to a connector adapted to receive a hose.

3. A wireless variable pressure sprayer according to claim 2, wherein an applicator wand is provided and is adapted for connection to the spray gun and hose for directing fluid under pressure to a desired target.

4. A wireless variable pressure sprayer according to claim 3, wherein the spray gun, including a trigger, is positioned on the applicator wand and adapted to wirelessly transmit a signal indicating the pressure and/or flow rate of the liquid to be delivered from the pump to the spray gun.

5. A wireless variable pressure sprayer according to claim 4, and including a variable pressure and/or flow rate controller positioned on the housing and connected to the motor for varying an output pressure and/or flow rate percentage of the pump.

6. A wireless variable pressure and/or flow rate sprayer according to claim 5, wherein the variable pressure controller is mounted externally to the side of the housing.

7. A wireless variable pressure and/or flow rate sprayer according to claim 5, wherein the battery supplies 18 V direct current to the motor that powers the pump, the pump adapted to draw liquid from the tank through a pump input conduit that pressurizes the liquid and discharges the liquid into an output conduit that is connected through a sidewall of the housing to the hose.

8. A wireless variable pressure sprayer according to claim 1, wherein the wireless variable pressure sprayer is adapted to supply liquid at a manually selectable high or low pressure.

9. A wireless variable flow rate sprayer according to claim 1, wherein the wireless variable pressure sprayer is adapted to supply liquid at a manually selectable high or low flow rate.

10. A wireless variable pressure and/or flow rate sprayer according to claim 1, wherein the pump is controlled wirelessly via a signal transmitted from the spray gun to a signal receiver operatively associated with the motor indicative of an instruction to the pump to turn on.

11. A wireless variable pressure sprayer according to claim 10, wherein the spray gun is adapted for manual operation by a user wirelessly controlling the output pressure of the liquid by operation of the spray gun.

12. A wireless variable pressure and/or flow rate sprayer according to claim 10, wherein the wireless signal is adapted for being fed back to the electronic control module whereby the user can manually set a desired pressure and/or flow rate and the pump speed changes according such that the desired pressure and/or flow rate is constant.

13. A wireless variable pressure and/or flow rate sprayer according to claim 4, wherein the trigger is provided with two positions correlated to the desired pressure, and further wherein a demand for high or low pressure causes a wireless signal to be transmitted from the electronic control module to a receiver/controller on the motor to transmit current from the battery to the motor sufficient to cause the pump to deliver the desired pressure and/or flow of liquid through the hose, the spray gun and into the applicator wand.

14. A wireless variable pressure sprayer according to claim 4, wherein the trigger includes a switch that when switched on, causes the transmitter in the spray gun to transmit a signal correlated to a specific desired pressure and/or flow rate within a predetermined range of pressures and/or flow rates determined by a position of the trigger that is correlated to predetermined range of pressures and/or flow rates.

15. A method of providing a liquid at a variable pressure and/or flow rate to an applicator wand, comprising the steps of providing:
(a) a housing on which is mounted a battery, a battery-operated motor, and a motor-operated liquid pump;
(b) a tank communicating with the pump for holding a supply of liquid;
(c) a spray gun connected for liquid flow communication from the tank; and
(d) a wireless transmitter positioned in the spray gun and adapted to transmit a wireless signal to a receiver/controller, signaling the battery to transmit current from the battery to the motor operated pump sufficient to cause the pump to deliver liquid through the spray gun and into the applicator wand; and
(e) manually operating the spray gun to wirelessly control the output pressure of the liquid by operation of the spray gun.

16. A method according to claim 15, and including the step of supplying liquid at a manually selectable high or low pressure.

17. A method according to claim 15, and including the step of supplying liquid at a manually selectable high or low flow rate.

18. A method according to claim 15, and including the step of feeding back the wireless signal to the electronic control module whereby the user can manually set a desired pressure and the pump speed changes according to flow such that the desired pressure is constant.

19. A method according to claim 15, and including the step of transmitting a wireless signal correlated to a specific desired pressure within a predetermined range of pressures to the pump, determined by a position of the trigger that is correlated to predetermined range of pressures.

20. A method of providing a liquid at a variable pressure to an applicator wand, comprising the steps of providing:
(a) a housing on which is mounted a battery, a battery-operated motor, and a motor-operated liquid pump;
(b) a tank communicating with the pump for holding a supply of liquid;
(c) a spray gun connected for liquid flow communication with the tank; and
(d) a wireless transmitter positioned in the spray gun and adapted to transmit a wireless signal to a receiver/controller, signaling the battery to transmit current from the battery to the motor sufficient to operate the motor operated pump to cause the pump to deliver liquid through the spray gun and into a manually-directed applicator wand at a manually selectable high or low pressure;
(e) manually operating the spray gun to wirelessly control the output of the liquid by operation of the spray gun;
(f) feeding back the wireless signal to an electronic control module whereby the user can manually set a desired pressure that changes according to flow such that the desired pressure is constant; and
(g) transmitting a wireless signal correlated to a specific desired pressure within a predetermined range of pressures to the pump, determined by a position of the trigger that is correlated to predetermined range of pressures.
